(19) United States
(12) Patent Application Publication
(10) Pub. No.: US 2025/0162014 A1
(43) Pub. Date: May 22, 2025

(54) WHEEL DISC FOR VEHICLE WHEELS, METHOD OF MANUFACTURE AND VEHICLE WHEEL

(71) Applicant: Maxion Wheels Holding GmbH, Königswinter (DE)

(72) Inventors: Renato de Jesus Madeira, Vinhedo (BR); Alexandre André Costa Motta, Sao José do Alegre (BR); Marcelo Yumoto Graziani, Limeira (BR); Adriano Phoenix Sant'Anna, Pocos de Caldas (BR); Marcio Aparecido de Oliveira, Limeira (BR); Ralf Duning, Solingen (DE); Iosef Fanizza, Königswinter (DE)

(73) Assignee: Maxion Wheels Holding GmbH, Königswinter (DE)

(21) Appl. No.: 18/841,802

(22) PCT Filed: Mar. 2, 2023
(86) PCT No.: PCT/IB2023/051953

§ 371 Date: Aug. 27, 2024

(30) Foreign Application Priority Data
Mar. 4, 2022 (DE) 10 2022 105 159.5

(51) Int. Cl. B21D 22/18; B21D 53/30; B60B 3/04; B60B 3/10

(52) U.S. Cl. CPC B21D 22/18; B21D 53/30; B60B 3/04; B60B 3/10; B60B 2310/213; B60B 2310/224; B60B 2310/226

(57) ABSTRACT

A wheel disc for vehicle wheels manufactured by flow forming, in particular for passenger cars, which has a stretched disc transition surface subsequently provided with ventilation holes and a radial outer disc edge. All ventilation holes are located in the transition surface and are attached by punching or cutting. In order to improve the competitiveness of vehicle wheels made of steel or other materials suitable in particular for cold forming compared to cast vehicle wheels made of aluminium, the transition surface is provided with several changes in material thickness generated during flow forming by displacement of the tool and, viewed in the radial direction, effecting a wave structure on the surface facing the tool during flow forming. The surface provided with the wave structure can in particular form the non-visible inner side of a vehicle wheel, but can also form the visible side. In addition, the opposite surface can also be provided with a wave structure.

### CROSS-REFERENCE TO RELATED APPLICATIONS

This application is a national stage of International Application No. PCT/IB2023/051953, filed 2 Mar. 2023, the disclosures of which are incorporated herein by reference in entirety, and which claimed priority to German Patent Application No. 10 2022 105 159.5, filed 4 Mar. 2022, the disclosures of which are incorporated herein by reference in entirety.

### BACKGROUND TO THE INVENTION

The invention relates to a wheel disc for vehicle wheels, in particular passenger cars, with a wheel disc body manufactured from a metallic preform by means of flow forming with a tool against a spinning chuck, which wheel disc body has a radial inner connecting flange provided with several bolt holes and a central hub hole, a stretched disc transition surface subsequently provided with ventilation holes and a radial outer disc edge, wherein the transition surface has a material thickness that, at least partially, changes several times when viewed in the radial direction, and all ventilation holes are attached by punching or cutting between a first inner ring section generated during flow forming, which is arranged between the connecting flange and the transition surface, and a second outer ring section generated during flow forming, which is arranged between the transition surface and the disc edge. The invention further also relates to a method for manufacturing wheel discs for vehicle wheels, in particular for passenger cars, with the steps a) flow forming a metallic preform on a flow forming machine against a spinning chuck by means of at least one spinning roller as a tool, b) generating a connecting flange, a disc transition surface and a disc edge on a wheel disc body in the flow forming step, wherein the transition surface in the flow forming step is at least partially given a material thickness that changes several times when viewed in the radial direction, c) generating a first inner ring section between the connecting flange and the transition surface and a second outer ring section between the transition surface and the disc edge, and d) punching or cutting ventilation holes in a subsequent processing step in the transition surface.

Vehicle wheels made of metal can be manufactured in various ways. Aluminium wheels are often manufactured as cast wheels, partially also as one-piece cast wheels with wheel disc and wheel rim. With steel wheels, on the other hand, it is usual to first produce a wheel disc and a wheel rim on separate manufacturing lines, which are then connected to one another in a suitable manner, for example by a welded joint. Numerous methods exist as manufacturing methods for the wheel disc on the one hand and for the wheel rim on the other hand. The present invention is primarily aimed at wheel discs made of steel and a manufacturing method for such a wheel disc made of steel, but also relates to a correspondingly assembled vehicle wheel consisting of a wheel disc and a wheel rim connected to it.

In principle, it is known to use a flow forming method for the manufacture of the wheel disc from a metallic preform. Here, a starting blank is clamped on a spinning chuck of a flow forming machine, usually in the area of the hub connecting flange, and then, while the spinning chuck is rotating, the preform is deformed to the final shape specified or desired for the wheel disc using suitable tools, in particular rotating spinning rollers. Reference is made to DE 21 565 51A1 as an example. The correspondingly manufactured wheel disc has a comparatively smooth surface, in particular on the side facing the spinning chuck, and can also have a material thickness that decreases steadily in the radial direction, for example from the inside to the outside, due to the stretching achieved during flow forming.

In the manufacture of wheel rims, it is generally known to provide certain areas of the wheel rim with a reduced material thickness by either stretching certain areas or thinning them out.

A method for manufacturing a wheel disc manufactured by flow forming and a wheel disc, in particular for commercial vehicle wheels is known from WO 2015/159231 A1, in which the spinning chuck for achieving local changes in material thickness in the wheel disc or a wheel disc preform is provided with local elevations, which generate corresponding local changes in material thickness in the wheel disc during flow forming of the wheel disc. The achieved changes in material thickness are only local, which is why different material thicknesses result in the circumferential direction on a specific pitch circle. The particular task of WO 2015/159231 A1 is to achieve material savings in the manufacture of corresponding vehicle wheels, along with the advantage of weight reduction, which can be achieved in less stressed areas or areas that will be omitted later, for example, due to the ventilation holes. Particular emphasis is therefore placed in this prior art on wheel discs for commercial vehicle wheels in which, where ventilation holes are later punched out, a significant minimization of the material thickness is already carried out in advance during the manufacture of the wheel disc. This allows a wheel disc of a specific wheel size to be manufactured from a starting blank with a smaller diameter. The material thickness changes are only achieved where the spinning chuck is provided with corresponding elevations or depressions.

Aluminium wheels manufactured using the casting method offer a wide range of design options. However, cast aluminium wheels have structural disadvantages due to the considerable amount of energy required for the manufacture of an aluminium wheel. Similar applies to forged aluminium wheels. Steel wheels or vehicle wheels manufactured from metal blanks by deformation can have a better overall energy balance in this regard, but with the disadvantage of fewer design options.

### SUMMARY OF THE INVENTION

It is a feature of the invention to improve the competitiveness of vehicle wheels made of steel or other materials suitable in particular for cold forming, in particular the competitiveness of a wheel disc made of steel, compared to cast vehicle wheels made of aluminium, and namely by means of a wheel disc and an economically competitive manufacturing method for a wheel disc which improves the design freedom in the positioning of ventilation holes while at the same time provides high rigidity and load-bearing capacity of the wheel disc.

This feature is achieved in its broadest application by a wheel disc, which is characterized in that the transition surface between the inner ring section and the outer ring section has several changes in material thickness generated during flow forming by displacement of the tool and, viewed in the radial direction, effecting a wave structure on the surface facing the tool during flow forming. A wheel disc with a wave structure manufactured during flow forming due to material thicknesses that change several times in the radial direction, whereas the material thickness, viewed in the circumferential direction, remains constant or essentially constant on a pitch circle within the wave structure, can be adapted in a better and more variable manner by suitable positioning of the wave structure to the expected loads that occur when a vehicle wheel provided with such a wheel disc is mounted on a vehicle. The wave structure caused by changes in material thickness can obtain greater material thicknesses in areas subject to greater stress than in areas subject to less stress, wherein the changes in material thickness are generated by displacing the tool relative to the spinning chuck and in this respect can also be adapted and changed iteratively with a high degree of design freedom at low cost.

According to a first advantageous design, the outer disc edge of the wheel disc receives or has an end section which is or can be formed as a rim flange during flow forming or can be connected to a wheel rim in such a way that a rear side of the preform formed into the wheel disc by flow forming and facing the spinning chuck can be used as a visible side of the wheel dish. A corresponding wheel disc thus has a wave structure which was produced exclusively by displacing the tool, and namely on the rear side or inner side of the later wheel disc facing away from the spinning chuck.

In principle, it is particularly advantageous in a wheel disc according to the invention if the transition surface, at least on the upper side of the preform facing the tool during flow forming, receives or has a wave structure with more than 3 wave crests and wave troughs lying in between, even better receives or has more than 5 wave crests and wave troughs lying in between, and in particular receives or has more than 7 wave troughs and wave crests lying in between on the wheel manufactured disc. Depending on the size of the wheel disc, significantly more wave troughs and wave crests can be generated or be present in the transition surface, for example also 14 to 20 (or even more) changes between wave troughs and wave crests. In addition, one or more wave troughs and/or wave crests can also be provided or generated in other areas of the wheel disc, in particular also in the radial inner ring section or in the radial outer ring section.

Preferably, most or all of the wave crests and wave troughs have radii of curvature, wherein further preferably wave crests and wave troughs adjacent to each other have different radii of curvature and/or the wave troughs have larger radii of curvature than the wave crests. However, individual wave troughs and wave crests can also have radii of curvature that are equal to each other. All radii of curvature can be equal to each other, even if a transition region with wave troughs and wave crests with different radii of curvature provides a clearly better match to the expected vehicle wheel loads. The size of the radii of curvature of the wave troughs can preferably increase in the radial direction from radially inside to radially outside.

According to an alternative design of a wheel disc or an additional design of a wheel disc, the transition surface on the rear side facing the spinning chuck during flow forming can, at least partially, have an uneven, wavy surface or wave structure viewed in the radial direction. This wave structure can only consist of wave troughs that generate changes in thickness, or it can also have an alternation of wave troughs and wave crests, which respectively cause different material thicknesses.

In all of the aforementioned designs of a wheel disc, it is possible or is particularly advantageous if the ventilation holes in the transition surface have at least two hole contours that differ from one another or hole contours arranged differently from one another, wherein these hole contours together form a pattern field which is repeated in the circumferential direction at least one more time, and is preferably repeated at least 3 times. Unlike conventional vehicle wheels with a regularly repeated hole contour in the circumferential direction, a wheel disc according to the invention can have several different hole contours that are combined with one another in such a way that the hole pattern generated with these hole contours is repeated several times in the circumferential direction. In combination with the wave structure of the wheel disc in the transition surface, this results in a significantly improved load carrying capacity and rigidity of a vehicle wheel, wherein the regularity of the pattern field prevents additional imbalances. It is particularly advantageous if each pattern field has several ventilation holes with different outer contours and intermediate struts between the ventilation holes with changing material thickness. The change in the material thickness in the intermediate struts between the ventilation holes is hereby caused by the wave structure which the wheel disc according to the invention receives during flow forming even before the ventilation holes are punched or cut. The intermediate struts in turn enable an additional improvement of the wheel disc or a vehicle wheel provided with it regarding the loads occurring during driving.

Alternatively or additionally, each pattern field can have at least one partial section partially forming the transition surface, which section adjoins the inner ring section, is not interrupted by ventilation holes, and has a changing material thickness seen in the radial direction. This creates, viewed in the circumferential direction, intermediate areas with ventilation holes and more or less pronounced areas without ventilation holes, which does not only achieve an arbitrary styling, but at the same time, together with the wave structure, can further improve the load bearing capacity and rigidity of the wheel disc.

With every designs of the wheel discs according to the invention the ventilation holes in the transition surface can have at least two hole contours which differ from one another or hole contours which are arranged differently from one another, wherein bridge webs with a material thickness that changes in the radial direction are arranged between adjacent hole contours. Here, the changes in the material thickness in the bridge webs are also generated by the wave structure, which the wheel disc is given according to the invention by deformation during flow forming.

There are a variety of design options for the bridge webs, whose geometry and course is actually determined by the punching out or cutting of the ventilation holes. According to one design, the bridge webs can have a constant width at least partially over a partial extension length. Alternatively or additionally, several bridge webs can run parallel to one another or skew to one another and/or cross each other and/or the bridge webs can be designed as round curves, straight struts and/or asymmetrical struts. Due to the respective geometry and the course of the bridge webs as the remaining areas between the ventilation holes, a branched basic structure is achieved between the ventilation holes, and at the same time a branched basic structure between the hub connecting flange and the outer disc edge, whereby the flexural rigidity and the load-bearing capacity are improved together with the wave structure enabling this as a priority.

The arrangement of the bridge webs preferably meets the requirement for hole patterns or pattern fields that are repeated in the circumferential direction, but each hole pattern itself can be composed irregularly in order to create a bionic support structure, the positive effect of which on the load-bearing capacity and flexural rigidity is additionally improved due to the changes in material thickness provided according to the invention during deformation.

In the design with bridge webs it is particularly advantageous if several ventilation holes formed by different hole contours form a hole window group together with the associated bridge webs, which group covers a window area with a circumferential contour which corresponds to a round hole, a triangular hole with rounded corners or a square hole with rounded corners.

In addition to the wave structure in the wheel disc transition surface, it can be advantageous if at least the inner ring section has at least one material thickness that changes in the radial direction and preferably has a wave structure with preferably only one wave trough on the surface facing the tool during flow forming, wherein the inner ring section merges into the transition surface via a transition curve, which is preferably provided with a wave crest. In this design it is particularly advantageous if the inner ring section has a wave structure with one wave trough or two wave troughs between the connecting flange and the transition surface.

The wheel disc with the wave structure can principally form a so-called semi-full-face wheel and can correspondingly be combined with a wheel rim, which then also has the outer rim flange in the usual manner. However, it is particularly preferred that the wheel disc is designed as a full-face wheel disc with a rim flange and, more preferably, the outer ring section of the wheel disc receives or has a ring zone with a surface that is planar on the visible side, preferably aligned orthogonally to an axis of rotation of the wheel disc or a vehicle wheel, wherein the ring zone has a radial length in the radial direction of at least 25 mm, 28 mm, 32 mm or 35 mm, depending on the wheel size, and/or, depending on the wheel size, has a length in the radial direction which is greater than 1/20 of the wheel disc diameter, and particularly preferably is greater than 1/16 or 1/15 of the wheel disc diameter. The ring zone that is already pronounced on the wheel disc can improve the aerodynamic properties of a vehicle wheel equipped with such a wheel disc due to its extent in the radial direction, as air turbulence in the radial outer zones of a vehicle wheel can be minimized. Here, too, according to a possible design, the ring zone can have at least one wave crest, and preferably both a wave crest and a wave trough. However, the ring zone can also be designed without a change in material thickness and therefore have a constant thickness when viewed in the radial direction.

The above feature is also achieved by a method which, according to the invention, is characterized in that the transition surface between the inner ring section and the outer ring section receives several changes in material thickness generated during flow forming by displacement of the tool and, viewed in the radial direction, effecting a wave structure on the surface facing the tool during flow forming, wherein in a subsequent method step all ventilation holes are attached by punching or cutting at least two hole contours that are different from one another or differently arranged hole contours between the inner ring section and the outer ring section, and the arrangement of the ventilation holes and the remaining basic structure on the wheel disc body form a pattern field in the transition surface which field is repeated at least one further time in the circumferential direction, and preferably at least three times.

The method according to the invention therefore combines the manufacture of the wheel disc with a wave structure and the arrangement or formation of the ventilation holes using the wave structure with different hole contours and thus pattern fields.

An advantageous variant for the method provides that several ventilation holes with mutually different outer contours are provided in each pattern field, wherein intermediate struts with changing material thickness result between the ventilation holes and at least one partial section is generated which adjoins the inner ring section, is not interrupted by ventilation holes, and partially has a changing material thickness.

In order to be able to form the wheel disc, which has a corrugated structure with a constant or essentially constant material thickness in the circumferential direction and changing several times in the radial direction as a result of the method according to the invention, in a particularly advantageous manner and to adapt it to the loads, the method control during manufacture can be carried out in such a way that that each pattern field of ventilation holes, bridge webs or intermediate struts and partial sections is determined iteratively in several steps, wherein, in a first step, basic pattern fields with ventilation hole contours are developed from the parameters of rigidity and load-bearing capacity required for a vehicle wheel, which contours are analysed in at least one further step with respect to feasibility, wherein, in a further step, prior to the manufacture of the wheel disc, the arrangement and the contour of the ventilation holes and the change in material thickness between the ring section effecting the wave structure and the position, shape and alignment of the bridge webs or intermediate webs are optimized with respect to vehicle wheel weight and rigidity. Such an iterative process enables the manufacture of wheel discs for vehicle wheels that leave the greatest possible freedom of design in terms of styling and at the same time are optimized for the expected loads.

A wheel disc according to the invention or a wheel disc manufactured according to the invention by flow forming in combination with hole contours arranged in pattern fields is used in particular for a vehicle wheel for passenger cars. It is also particularly expedient here if the wheel disc is connected to the wheel rim in such a way that the front side visible in the assembly state of the vehicle wheel on a vehicle consists of the viewing side of the side of the wheel disc body that is pressed against the spinning chuck during flow forming or in the flow forming step. The wave structure then lies, preferably exclusively, on the inside of the wheel disc within the wheel rim, thus facing the vehicle and the vehicle brake. In the case of the vehicle wheel, too, it is particularly advantageous if the wheel disc forms a fully formed rim flange and a rim section is connected to the rear side of the wheel disc in the area of the preferably planar outer ring section, preferably offset radially outwards relative to the outer transition curve into the outer ring section, thus if the wheel disc is designed for a full-face vehicle wheel. Here, too, the aerodynamics of a vehicle wheel can be improved if the wheel disc on the outer ring section has a ring zone with a planar surface, preferably aligned orthogonally to an axis of rotation of the vehicle wheel, wherein the ring area has a radial length of several centimetres, which length preferably is greater, depending on the wheel diameter, than at least 25 mm, 28 mm or 32 mm, or even greater than at least 35 mm in the radial direction, and/or if the ring zone has a length in the radial direction that is greater than 1/20 of the wheel disc diameter, and preferably greater than 1/16 or more preferably 1/15 of the wheel disc diameter. The radial length of the planar outer ring section may also range from about 10% to 30% of the entire radial length of inner ring section, transition surface and outer ring section together.

Other advantages of this invention will become apparent to those skilled in the art from the following detailed description of the preferred embodiments, when read in light of the accompanying drawings.

### BRIEF DESCRIPTION OF THE DRAWINGS

FIG. 1 is a sectional view through a vehicle wheel according to the invention with a wheel disc according to the invention according to a first embodiment variant together with a schematically indicated wheel hub cap and a schematically indicated brake profile;

FIG. 2 is a schematic, highly simplified view the basic procedure for producing a wheel disc according to the invention;

FIG. 3 is a sectional view similar to FIG. 1 without hub cap and brake profile;

FIG. 4 is an enlarged sectional view, the cross-sectional profile of a wheel disc according to the invention according to the embodiment variant according to FIGS. 1 and 3;

FIG. 5A is the vehicle wheel from FIG. 1 in a perspective view of the front side;

FIG. 5B is the vehicle wheel from FIG. 1 in a perspective view of the rear side;

FIG. 6A is in plan view a wheel disc for a vehicle wheel according to a second embodiment variant;

FIG. 6B is in plan view a wheel disc for a vehicle wheel according to a third embodiment variant;

FIG. 6C is in plan view a wheel disc for a vehicle wheel according to a fourth embodiment variant;

FIG. 7 is an enlarged sectional view, similar to FIG. 4, the cross-sectional profile of a wheel disc according to the invention according to a fifth embodiment variant;

FIG. 8A is a perspective view, a vehicle wheel with the wheel disc according to the invention according to the fifth embodiment variant in view of the front side;

FIG. 8B is a perspective view, the vehicle wheel according to the fifth embodiment variant in view of the rear side;

FIG. 9 is an enlarged sectional view, similar to FIG. 8, the cross-sectional profile of a wheel disc according to the invention according to a sixth embodiment variant;

FIG. 10A is a perspective view, a vehicle wheel with the wheel disc according to the invention according to the sixth embodiment variant in view of the front side;

FIG. 10B is a perspective view, the vehicle wheel according to the sixth embodiment variant in view of the rear side;

FIG. 11 is an enlarged sectional view, schematically greatly simplified, the cross-sectional profile of a vehicle wheel in a full-face embodiment with a wheel disc according to a seventh embodiment variant;

FIG. 12 is an enlarged sectional view, schematically greatly simplified, the cross-sectional profile of a vehicle wheel in a semi-full-face embodiment with a wheel disc according to an eighth embodiment variant;

FIG. 13 is a front view of a wheel disc according to the invention according to a ninth embodiment variant with bridge webs between ventilation holes of a ventilation hole pattern field that is repeated several times;

FIG. 14 is an enlarged view of a ventilation hole pattern field with straight bridge webs crossing each other between ventilation holes;

FIG. 15A is an enlarged view of a ventilation hole pattern field with straight and curved bridge webs between ventilation holes;

FIG. 15B is an enlarged view of a ventilation hole pattern field with straight, sloping bridge webs between ventilation holes;

FIG. 15C is an enlarged view of a ventilation hole pattern field with straight and curved bridge webs each other between ventilation holes; and

FIG. 15D is an enlarged view of a ventilation hole pattern field with serpentine bridge webs between ventilation holes.

### DETAILED DESCRIPTION OF THE INVENTION

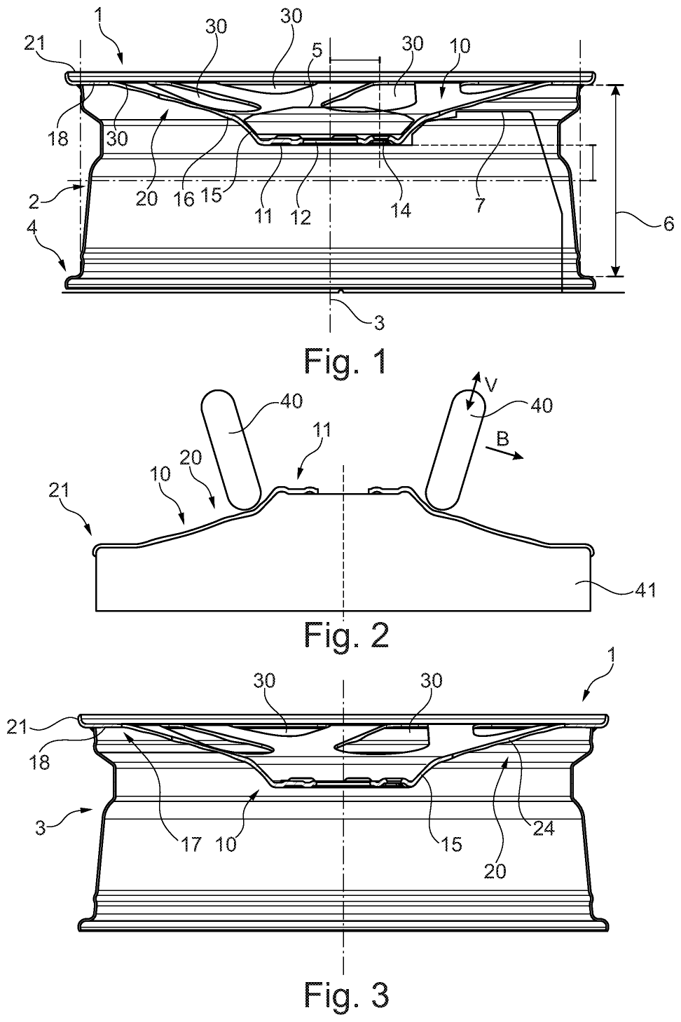

In FIGS. 1 and 3, reference numeral 1 designates a vehicle wheel, in particular for passenger cars. It is an assembled vehicle wheel 1 consisting of a rim part 2 and a wheel disc 10. Preferably, both the rim part 2 and the wheel disc 10 consist of steel, and both parts are connected to one another by a welded joint. However, the wheel disc could also consist of other formable materials, in particular cold-formable materials, including, for example, suitable light metal materials. In the case of a composite vehicle wheel, the rim could also consist of different materials than the wheel disc, e.g. of light metal with a wheel disc made of steel. The vehicle wheel 1 has a wheel axle 3 which coincides with the axis of rotation of the wheel rim 2 and the wheel disc 10. The structural design of the wheel rim 2 is essentially irrelevant to the present invention. The vehicle wheel 1 forms a so-called full-face wheel, because the wheel disc 10 already has an integral outer rim flange 21, which at least in Europe is usually part of a wheel rim in passenger cars. The wheel disc 10 is therefore designed in a full-face shape, and the wheel rim 2 is correspondingly designed shortened without a rim flange. In FIG. 1, a hub cap or centre cap 5 is indicated additionally, which can be used to cover a central inner connecting flange 11 that is common on vehicle wheels on the wheel disc 10.

The vehicle wheel 1 is fastened to the wheel hub of a vehicle, such as a passenger car in particular, via the connecting flange 11 of the wheel disc 10. The hub connecting flange 11 therefore additionally has a central hub hole 12 and, on a pitch circle around the hub hole 12, several bolt holes 14 for wheel bolts to pass through, which are screwed into the hub of a vehicle. A passenger car wheel usually has between 3 and 6 bolt holes. The essentially flat connecting flange 11 of the wheel disc 10 merges radially outwards into a (wheel) disc transition surface 20, which is curved outwards and ends at the edge of the wheel disc 10 in a disc edge 21, which, due to the design of the vehicle wheel 1 as a full-face wheel, forms the rim flange at the same time. A tyre that is mounted on the vehicle wheel 1 would correspondingly lie radially inward supported on the wheel rim 2 between the disc edge 21 forming the one rim flange at the same time and an inner rim flange 4 integrally formed on the wheel rim 2, as symbolically indicated by the double arrow 6 in FIG. 1. In principle, the length of the double arrow 6 corresponds to the tyre width of a suitable tire. On a vehicle wheel, the designations inner, below or rear usually refer to that side which is not visible in the mounting state of a vehicle wheel on a vehicle, whereas outer or front designates the visible side. On the other hand, radial inner and radial outer refer to the extension in the radial direction starting from the wheel axle 3.

The curvature of the disc transition surface 20 of the wheel disc 10 is in turn determined, among others, by the brake profile contour indicated by the line 7, as the vehicle wheel must maintain a distance from this brake profile contour specified on the vehicle. During the manufacture of the wheel disc in a subsequent method step, the disc transition surface 20 is further provided with ventilation holes, which are generally indicated by reference numeral 30 in FIGS. 1 and 3. The ventilation holes 30 fulfil several purposes; they ensure a weight reduction, enable sufficient cooling of the brake and at the same time influence the external appearance (“styling”) of a vehicle wheel. The ventilation holes 30 are hereby arranged between an inner ring section 15 and an outer ring section 18. The area between the inner ring section 15 and the outer ring section 18 forms the disc transition surface 20 at the same time, wherein a first transition curve 16 between the inner ring section 15 and the radially inner start of the transition surface 20 and a second outer transition curve 17 between the radially outer end of the transition surface 20 and the radially outer ring section 18 are additionally formed. The angles of the transition curve 16 and transition curve 17 are selected in such a way that the transition surface 20 runs at an angle of approximately 12-25°, preferably at an angle of approximately 16° to 18° to the hub connection flange 11, as indicated in the exemplary embodiments shown.

A special feature of the wheel disc 10 according to the invention, and to this extent also of every vehicle wheel 1 provided with it, consists in the cross-sectional profiling in particular of the transition surface 20, and the attachment options and design options for ventilation holes 30 made possible in particular by this. In FIGS. 1 and 3, it is already indicated that the disc transition surface 20 on the inside or rear side 24 of the wheel disc 10 has a wave structure effecting changes in material thickness, which was generated during the manufacture of the wheel disc 10 by means of flow forming. This wave structure forms one of the features essential to the invention, as the wave structure extends concentrically in a constant manner along the entire circumference of the disc transition surface 20 and provides several changes in material thickness viewed in the radial direction, particularly in the disc transition surface 20.

FIG. 2 is referred to for explaining the basic principle of the flow forming method used during the manufacture of the wheel disc 10 according to the invention. FIG. 2 illustrates the procedure in an extremely schematic manner. A metallic preform, for example a round circuit board, is usually pre-profiled by suitable pre-treatment steps with formation of a central hub connecting area if necessary with a centre hole, and it is then flow-pressed against the surface contour of a spinning chuck 41 by means of spinning rollers, which, as shown, preferably consist of rotating spinning rollers 40. The correspondingly pre-profiled preform is hereby held in place with hold-down tools, not shown, preferably in the central inner area, which later forms the hub connecting flange 11. In the hub connecting flange 11, the preform, as well as the later wheel disc, can therefore essentially continue to have the initial thickness of the preform, which is usually between about 3 mm and 7 mm in passenger cars. During the subsequent flow forming, as shown, the spinning chuck 41 is rotated together with the preform on a suitable flow forming machine. On the one hand, the tools 40 move radially outwards along the surface contour of the spinning chuck 41, as indicated by arrow B, and at the same time the distance between the spinning roller 40 and the spinning chuck 41 can be adjusted, as indicated by arrow V. The spatial surface contour of the spinning chuck 41 corresponds to the spatial contour of the later wheel disc 10. By adjusting the spinning rollers 40 in the direction of arrow V, the material thickness of the wheel disc 10 is provided with a wave structure in particular in the disc transition surface 20, which is only indicated in FIG. 2, wherein the maximum thinning in the area of the wave structure with the lowest material thickness can be up to 40% of the initial material thickness of the preform. The wheel disc 10, which can be used to design a full-face vehicle wheel, is designed completely hereby, and namely including the rim flange 21, in that also the free ends of the preform are angled around the spinning chuck 41 and are pressed against with the spinning rollers 40. In this manufacturing method, the surface of the wheel disc 10 facing the spinning chuck 41 obtains a smooth surface that is also of high optical quality, whereby it can be used directly as the visible surface of a vehicle wheel. The wave structure, on the other hand, results with the spinning chuck 41 shown in FIG. 1 only on the surface or side facing the spinning rollers 40 as tools, which surface or side forms the rear side or inner side of the wheel disc 10, as it lies in the non-visible inner area of a vehicle wheel. By means of the flow forming/flow pressure rolling and the thinning of the material thickness caused by the wave structure, the disc transition surface 20 is stretched at the same time.

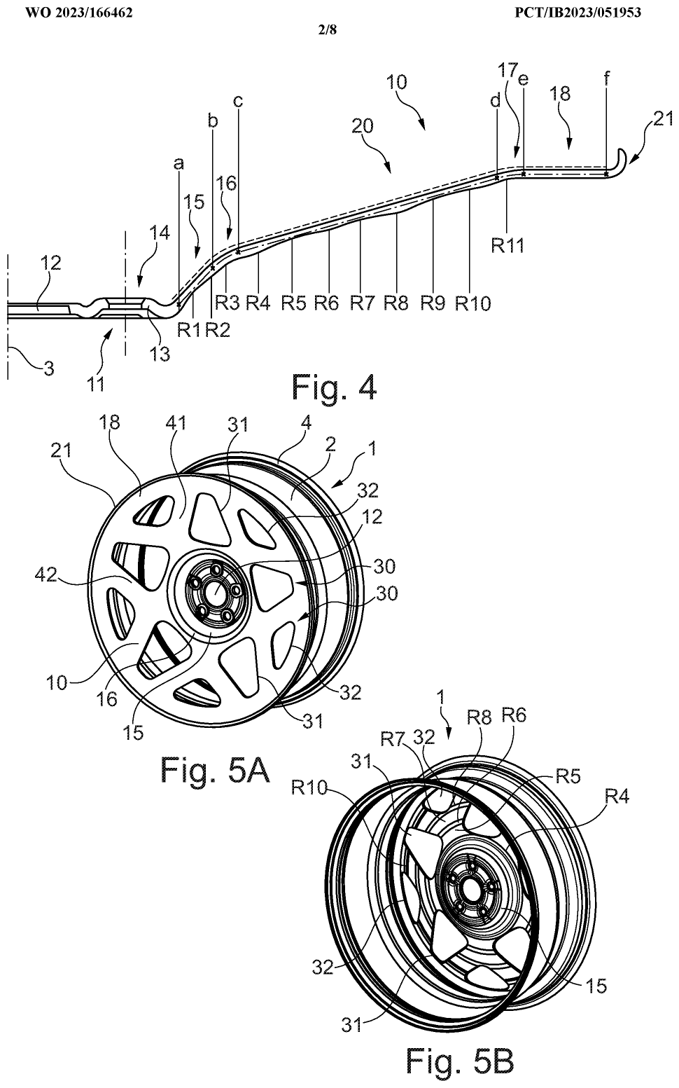

For a better explanation of the wave structure, reference is now made to FIG. 4, 5A and 5B, which show the cross-sectional profile and spatial profile of the wheel disc 10 in a schematically enlarged view by way of example. The wheel disc 10 is hereby only shown in half; as usual, the hub connecting flange 11 has the hub hole 12 as well as a raised ring area 13 for bolt holes 14, which are respectively designed as humps. At its radially outermost extent, the hub connecting flange 11 merges into a radial inner ring section 15 which, in the exemplary embodiment shown, runs in a pot-like manner in relation to the hub connecting flange 11 and curves upwards or forwards in an oblique manner. The ring section 15, as indicated by the position a in FIG. 4, extends substantially between the radial outermost bearing area of the hub connecting flange 11 on a hub and the start of a radial inner transition curve 16 extending between the radial inner position b and the radial outer position c in FIG. 4. This transition curve 16 is adjoined by the disc transition surface 20, in which the wave structure is designed with multiple changes in material thickness according to the invention (at least) during flow forming. In the exemplary embodiment shown, the disc transition surface 20 extends at an approximately constant oblique angle from position c, thus the radial outer end area of the inner transition curve 16, to a radial outer transition curve 17, which extends between positions d and e in FIG. 4. This transition curve 17 is adjoined by the outer ring section 18, which has the outer rim flange 21 integrally here, which at the same time forms the radial outer wheel disc end.

In the exemplary embodiment in FIG. 4, the wheel disc transition surface 20 has a wave structure with 3 wave troughs R5, R7, R9 and 4 wave crests R4, R6, R8, R10. In the wave troughs R5, R7, R9, the material thickness is lowest compared to the adjacent zones, in the wave crests R4, R6, R8, R10 the material thickness is greatest compared to the adjacent zones. In the exemplary embodiment shown, the transition surface 20 has the greatest material thickness at the wave crest R10 and the smallest material thickness at the wave crest R5. This is only an example, as the number of wave troughs and wave crests and also the position and radius of curvature of the wave troughs with the locally lowest material thickness and the wave crest with the greatest local material thickness can be varied depending on the wheel size and the expected vehicle wheel loads. At the same time, it is understood that the material thickness usually decreases steadily from the centre of a wave crest to the bottom of a wave trough. The marking lines for the wave troughs and wave crests therefore usually denote the wave crest or the trough in the figures, thus the local position of minimum or maximum material thickness. The radial outer transition curve 17 is adjoined by the radial outer ring section 18, which in the exemplary embodiment according to FIG. 4 extends over several centimetres, preferably more than 28 mm to 30 mm, preferably more than 35 mm, in particular more than 40 mm, essentially exactly perpendicular to the wheel axle 3, and also has a constant material thickness between positions e and f. The outer ring section 18 then ends in the outer rim flange 21 which is integrally formed on the wheel disc and which immediately adjoins position f radially outwards. The section of the outer ring section 18 running perpendicularly to the wheel axle forms a ring zone which can have a positive influence on the overall aerodynamics and can contribute to minimizing the air resistance, in particular with vehicle wheels in which wheel caps extending up to the edge of the disc are dispensed with, in particular if the radial length of the ring zone is at least 30 mm or even at least 35 mm or at least 1/20, more preferably at least 1/16 or 1/15 of the wheel size. The depth of offset between the ring zone 18 and the hub connecting surface 11 can be between approximately 30 mm and 110 mm depending on the wheel diameter as well as the brake contour of the vehicle for which the vehicle wheel is intended. The wheel diameter also determines the radial distance between the positions a and f, thus the entire radial length of inner ring section 15, outer ring section 18 and transition surface 20 together, which entire radial length in particular can be in the range from about 120 mm to about 200 mm. The ring zone 18 between positions e and f, in turn, can make up about 10 to 30% of the aforementioned radial distance or entire radial length between positions a and f.

The radial inner transition curve 16 has a constant radius of curvature R3 here, and the radial outer transition curve 17 also has a constant radius of curvature R11, wherein the radius of curvature R3 is lower than the radius of curvature R11; the material thickness in transition bend 16, on the other hand, is significantly larger than in transition curve 17. The inner ring section 15 between the positions a and b also has a wave trough R1 and a wave crest R2 here, which were generated during flow forming. The ring zone in the outer ring section 18, on the other hand, has a constant thickness in the exemplary embodiment according to FIG. 4.

The radii of curvature R5, R7, R9 of the wave troughs preferably increase radially outwards. The radial innermost radius of curvature R5 can be, for example, approximately 100 mm, the radius of curvature R7 can be 120 mm and the radius of curvature R9 can be 150 mm. The radii of curvature R4, R6, R8, R10 of the wave troughs, on the other hand, can be identical to one another, alternate between larger radii and smaller radii, or also respectively increase in the radial direction. The radii of curvature can be in the range of 50 mm-100 mm, for example, but can also be lower or higher. As a rule, the radii of curvature of the wave crests are significantly smaller than the radii of curvature of the wave troughs. The transition surface 20 can, for example, extend at an angle of approximately 16°-18° relative to the plane of the hub connecting flange 11. The ring zone can also be provided with a wave trough, or a wave trough in the area of the radial outer curvature curve 17 extends into the ring zone on the outer ring section 18. The radial innermost radius of curvature R1 of the first wave trough is preferably comparatively small, while the radius of curvature R2 of the first wave crest in the inner ring section 15 is preferably large, and larger than the radii of curvature of all other wave crests, particularly in the transition section 16. The ring section 15 can enclose an angle of approximately 40°-45° with the wheel axle.

FIG. 5A and 5B show a first embodiment variant of how a vehicle wheel 1 with a correspondingly profiled wheel disc 10 can be provided with ventilation holes. The front view in FIG. 5A illustrates once again that the visible side of the vehicle wheel 1, which is formed by the side of the preform facing the spinning chuck during flow forming with the wheel disc 10, has a high-quality smooth surface structure without scores or grooves and can therefore directly form the visible side of a vehicle wheel 1. The wave structure manufactured according to the invention, on the other hand, is located only on the rear side of the wheel disc 10, as is readily apparent from FIG. 5B, which, with a vehicle wheel 1, forms the non-visible inner side within the rim 2. The wave structure is indicated by concentric circles in the wheel disc of the vehicle wheel 1 in FIG. 5B, exemplified by the radii R5, R6, R7, R8 on the rear side of the wheel disc in FIG. 5. In a subsequent step, the wheel disc 10 manufactured correspondingly during flow forming has been provided with ventilation holes 30, which have two different hole contours in the wheel disc, namely on the one hand ventilation holes 30 with the hole contour 31 and further ventilation holes 30 with the hole contour 32. The ventilation holes with the hole contours 31 extend radially over a much greater length than the ventilation holes with the hole contours 32. The ventilation holes 30 with the hole contours 31 extend, for example, over the entire radial extension area between the wave crest R4 and the wave crest R10. The basic shape of the hole contour 31 essentially corresponds to a trapezoid with rounded corners. Whereas, the ventilation holes with the hole contours 32 are radially much further out and only extend radially in the area of the wave crests R8 to R10. The basic shape of the hole contour 32 is essentially triangular with rounded corners, wherein the basis or base side is radial on the outside and essentially runs curved on a reference circle. The ventilation holes 30 with the different hole contours 31, 32 can be punched or cut out with a suitable cutting tool. Between the ventilation holes with the hole contours 31, 32 there remain relatively wide bridge contours or bridge webs which are provided with the reference numerals 41 and 42 in FIG. 5A and which connect the outer ring section 18 to the inner ring section 15. Each of these bridge structures 41, 42 does not run radially and, due to the wave structure that the wheel disc has received here on the rear side and which ensures the changes in material thickness in the radial direction, also has changes in material thickness that bring about an improvement of the entire vehicle wheel regarding load carrying capacity and wheel rigidity. The ventilation holes with the hole contours 31, 32 in FIG. 5A, 5B are only exemplary, as the wave structure essentially increases the variability regarding the hole contours and the position and size of the ventilation holes 30. The ventilation holes with the hole contours 31, 32 are, viewed in the circumferential direction, arranged rotationally symmetrically; therefore, the ventilation holes with the hole contour 31 are repeated five times and the ventilation holes with the hole contour 32 are repeated five times seen in the circumferential direction. If the wheel disc is divided into five sub-segments of equal size, each sub-segment has a pattern field with a repeating sequence of ventilation holes with the hole contours 31 and 32.

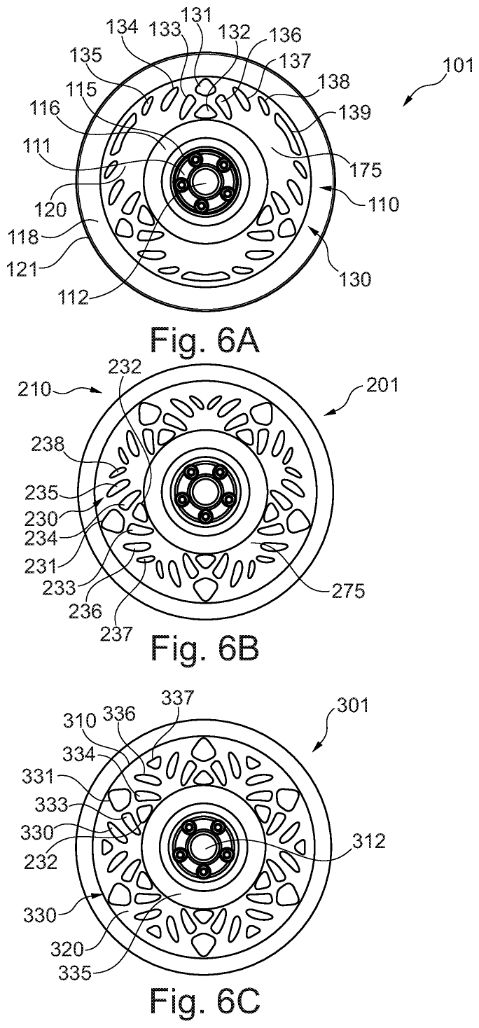

FIG. 6A, 6B, 6C show vehicle wheels with wheel discs which, as in the previous exemplary embodiment, have a wave structure on the non-visible rear side and which are given a completely different appearance by ventilation holes with different ventilation hole contours. FIG. 6A shows a vehicle wheel 101 in a plan view of the wheel disc 110. As in the previous exemplary embodiment, the wheel disc 110 has a hub hole 112, a hub connecting flange 111, an inner ring section 115, a radial further inner transition curve 116, a disc transition surface 120 provided with the ventilation holes 130, a radial outer ring section 118 and an outer rim flange 121 adjoining this, radially from the inside to the outside. The wave structure on the rear side is not shown, but it can also have eight wave crests and seven wave troughs here, for example. The ventilation holes 130 have nine different hole contours, which are designated with the reference numerals 131, 132, 133, 134, 135, 136, 137, 138, 139. These are partly hole contours that have a same basic shape but are mirror symmetrical to each other. This applies, for example, to the hole contours 135 and 138, the ventilation holes with the hole contours 134 and 137 and the ventilation holes with the hole contours 133 to 136. The pattern field formed from the ventilation holes 130 with the hole contours 131 to 139 is repeated three times in the direction of rotation, as can be clearly seen from the view in FIG. 6A. The individual hole contours are preferably cut, as this is economically advantageous compared punching. By means of the very different geometry of the individual hole contours, a very arbitrary styling results in turn and relatively large, pronounced partial sections 175 remain in the wheel disc 110 which are not provided with ventilation holes and adjoin directly adjacent to the inner ring section 115. Furthermore, bridge structures respectively remain between individual ventilation holes with the hole contours 131 to 139, which structures do not run radially but at the same time have changing material thicknesses due to the wave structure on the rear side. These bridge structures also effect branching between ventilation holes with the hole contours 131-139 with surprisingly advantageous effects regarding rigidity and load-bearing capacity.

FIG. 6B shows a third exemplary embodiment of a vehicle wheel 201 according to the invention with a wheel disc 210 with ventilation holes 230, which again consist of ventilation holes with eight different ventilation hole contours 231 to 238. Here too, for example, the ventilation holes with the hole contours 237, 238 or 236 and 235 respectively form pairs in which the hole contours have the same basic shape but are arranged mirror-symmetrically to one another. Overall, the hole pattern with the hole contours 231 to 238 is repeated five times in the direction of rotation, and between individual ventilation holes remain different bridge sections or bridge webs with material thicknesses changing in the radial direction due to the wave structure that the wheel disc 210 receives during flow forming. These bridge structures in turn ensure branching in the area of the ventilation holes 231-138, wherein 5 partial sections 275 also remain further inwards, which have no ventilation holes.

FIG. 6C shows a vehicle wheel 301 according to a fourth exemplary embodiment. Here, too, the wheel disc 310 receives a wave structure with, for example, eleven wave crests and ten wave troughs on the rear side that is not visible on the vehicle wheel 301 in the assembly state. Ventilation holes 330 are cut into the disc transition surface 320, for example by laser cutting, which holes consist of seven different hole contours 331, 332, 333, 334, 335, 336, 337. The ventilation holes with the hole contours 331 to 337 form a pattern field which is repeated six times in the circumferential direction. The ventilation holes with the hole contours 333, 334 or 335, 336 have the same basic shape to one another, but are mirror-symmetrical. An axis of mirror symmetry could be placed, for example, through the centre of the ventilation holes 331, 332, wherein the ventilation holes with the hole contours 337 would then also be assigned half to one pattern field and half to the other pattern field per pattern field. Even with such a design of the ventilation holes with different hole contours 331 to 337, the wave structure on rear side ensures improved rigidity and load-carrying capacity of the vehicle wheel 301. And also with the vehicle wheel 301, a partial section 375 which is not provided with ventilation holes 330 respectively forms around the hub hole 312 and the inner ring section.

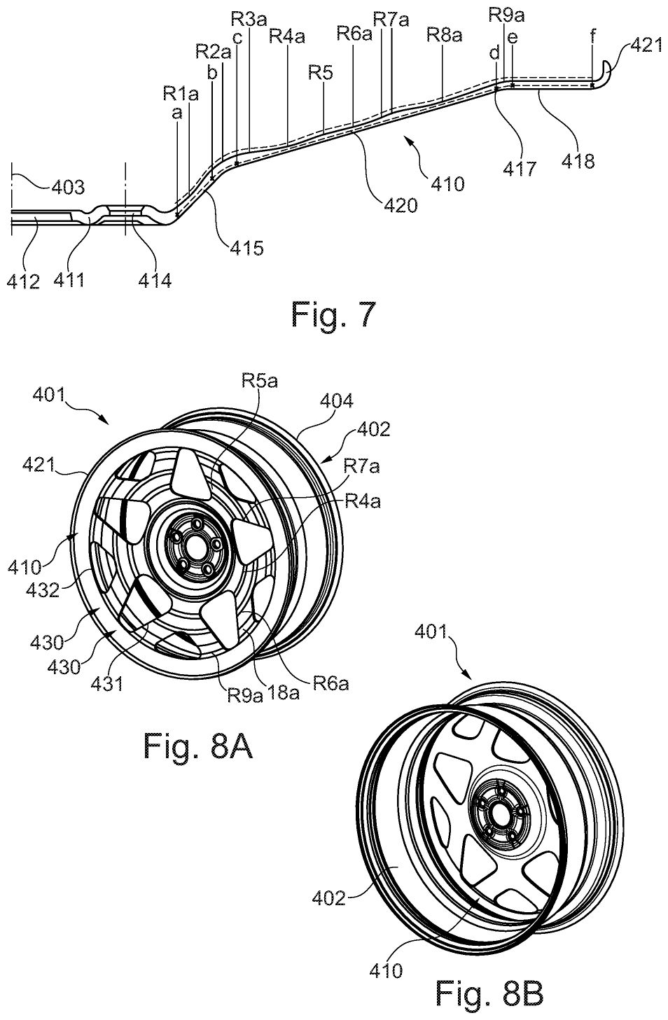

The formation of the wave structure on the non-visible rear side of a wheel disc designs the preferred exemplary embodiment. With regard to improving the flexural rigidity and load-carrying capacity, the wave structure could also be generated on the front side of a wheel disc 410 during flow forming, as indicated schematically in FIG. 7. The wheel disc 410 is also designed for a so-called full-face vehicle wheel and has, starting from the wheel axle 403 radially from the inside to the outside, a hub hole 412, a hub connecting flange 411 with raised bolt holes 414, an inner ring section 415, which extends between the positions a, b in FIG. 7, a radial inner transition curve 416 which extends between positions b and c in FIG. 7, a wheel disc transition surface 420 which extends between the positions c and d, a radial outer transition curve 417 between the positions d and e and an outer ring section 418 which extends between the positions e and f. The outer ring section 418 is immediately followed by the outer rim flange 421, which, however, cannot be manufactured during flow forming in the same clamping as the other sections of the wheel disc due to manufacturing reasons, but must be bent separately in an intermediate step, before or after the ventilation holes have been attached. During flow forming, the spinning rollers act on the front side of the wheel disc 410, which later forms the visible side, thus the upper side in FIG. 7. Here too, however, a wave structure with several wave crests R3a, R5a, R7a and wave troughs R4a, R6a, Ra is generated during flow forming by displacing the tools (spinning rollers). The radial inner transition curve 416 has a radius R2a and the radial outer transition curve 417 has a radius R9a, which coincides with a wave crest at the same time. At the wave crests R3a, R5a, R7a, R9a, the wheel disc 410 has a greater thickness locally, but in the wave troughs R4a, R6a, R8a it has a thinned, lower material thickness, which can amount to up to 60% of the starting material thickness. In particular, in the two transition curves 416, 417, the material thickness can additionally be thinned out, the same as with the radial inner ring section 415. The outer ring section 418 has a length that is at least 30 mm or 35 mm, preferably even more than 40 mm in the radial direction. The outer ring section 418 runs perpendicular to the axle 403 and serves to improve aerodynamics.

FIG. 8A and 8B show a vehicle wheel 401 with a corresponding wheel disc 410. The wheel rim 402 is again welded to the rear side of the wheel disc 410 and can essentially have any design suitable to support a tyre of the required tyre size between the rim flange 421, which forms an integral part of the wheel disc 410, and the rim flange 404, which is formed on the wheel rim 402. The wheel disc 410 of the vehicle wheel 401 is provided with ventilation holes 430 which, as in the first exemplary embodiment, have two different hole contours 431 or 432, wherein the ventilation hole with the hole contour 431 is repeated five times in the circumferential direction, the same as the ventilation hole with the hole contour 432. As the visible side was provided with the wave structure here, the concentric rings generated by the wave structure and which ensure the changes in material thickness appear on the visible side, as indicated in FIG. 8 by the radii of curvature R4a, R5a, R6a, R7a, R8a, R9a.

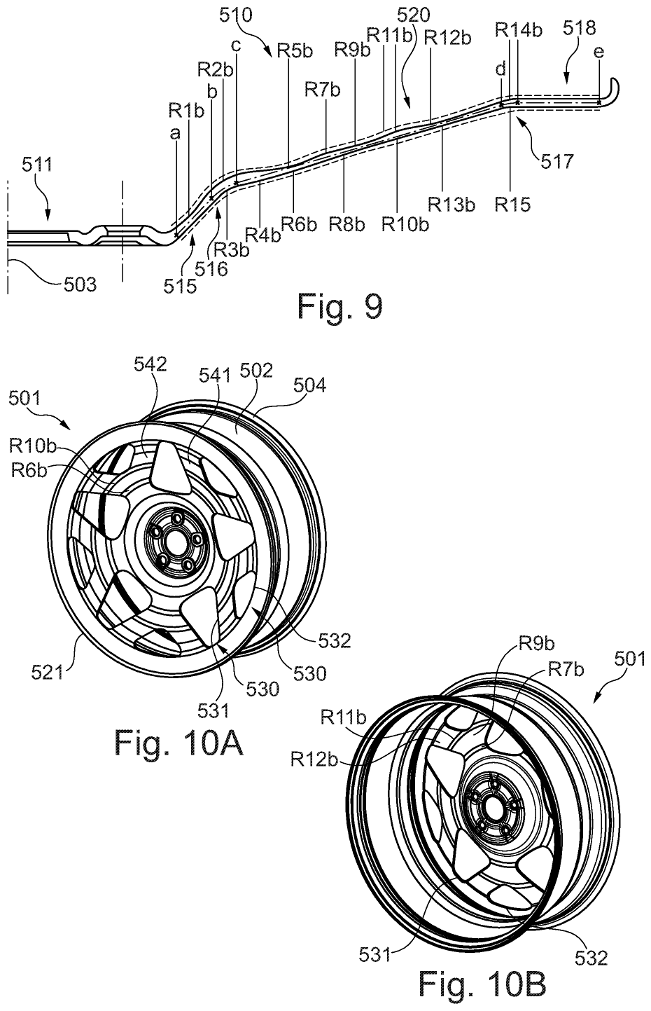

FIG. 9, 10A, 10B show a wheel disc 510 or a vehicle wheel 501 with a wheel disc 510 according to a sixth exemplary embodiment. Here, too, reference is first made to the sectional representation of the wheel disc 510 in FIG. 9. This wheel disc 510 is also manufactured by flow forming and, starting from the wheel axle 503, has a hub connecting flange 511, an inner ring section 515, a radial inner transition curve 516, a wheel disc transition surface 520, a radial outer transition curve, an outer ring section 518 and a rim flange 521. The positions a, b, c, d and e, which are intended to indicate the respective boundary areas of the individual aforementioned sections 515, 516, 520, 517, 518, are also drawn. In contrast to the two previous exemplary embodiments, both the lower front side of the wheel disc 510 in FIG. 9 and the upper rear or inner side of the wheel disc 510 are respectively provided with a wave structure. This results in wave crests R6b, R10b and wave troughs R4b, R8b, R13b on the front side. On the rear side, wave crests R7b, R11b, R14b and wave troughs R5b, R9b, R12b are respectively formed in the transition surface 520 during flow forming. As a wave structure is present on both sides, zones with a minimum material thickness develop in the transition surface 520 approximately in the area where the wave troughs meet, here for example in the area of the wave troughs R8b, R9b and R12b, R13b. In these areas, the thinning out during flow forming can be reduced to up to 40% of the starting thickness or at least 60% of the starting thickness. In order to design the wave structure on both sides, it is also necessary to provide the surface of the spinning chuck with an inverted wave exit contour, as the wave contour can only be generated on one side by displacing the tool. The radii of curvature of the wave crests R6b, R10b and wave troughs R4b, R8b, R13b at the front side (bottom side in FIG. 9) are preferably 3 to 6 times larger than the radii of curvature of the wave crests R7b, R11b and wave troughs R5b, R12b at the rear side. The radius R5b can be 100 mm for example, while the radius R13b is 600 mm. Here, too, the radii of curvature on the side facing the tool during flow forming can increase from radially inwards to radially outwards, so that the radius R5b is, for example, 50% smaller than the radius R12b. The wave crest R14b is essentially located in the radial outer transition curve 517, and the thinning of the material thickness can in particular be larger in the two transition curves 516, 517 than in the transition surface and in the outer ring section 518. Here, too, the outer ring section 518 proceeds as a ring zone, which extends perpendicularly to the wheel axle 503 over several millimetres, for example over more than 1/20 of the wheel size.

FIG. 10A and 10B illustrate this once again on a vehicle wheel 501 with the wheel disc 510 and a wheel rim 502 with the inner rim flange 504 connected to the rear side. The wave crests R6, R10 are formed on the front side and are visible, whereas the rear side has wave crests R7b with the wave trough R9b in between and the wave trough R12b radially further outward. The ventilation holes 530 with the trapezoidal hole contours 531 extend almost over the entire radial extension of the transition surface 520 and in this respect over the area of several wave crests and wave troughs. The ventilation holes with the hole contour 532, on the other hand, have a smaller radial extension and are located radially further outward only in the area of the wave crests R11b and R15b and the wave troughs R12b, R13b. The bridge sections 541, 542, which respectively develop between adjacent ventilation holes with the hole contours 531, 532, have corresponding changes in material thickness and do not proceed radially.

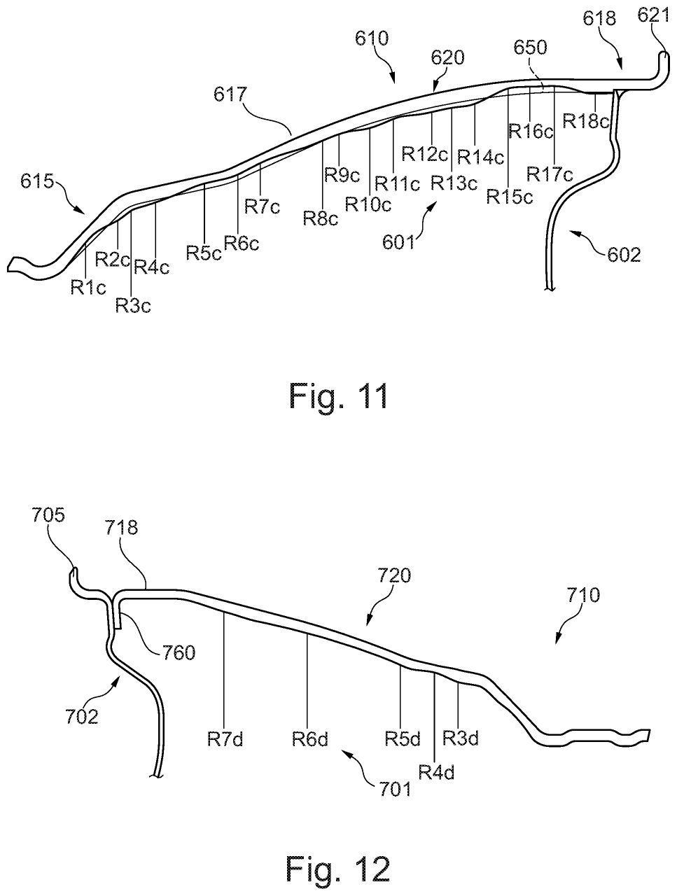

FIG. 11 shows a further cross-sectional profile of a wheel disc 610 according to the invention for a vehicle wheel 601 indicated only schematically with the wheel rim 602 shown in part. Here, too, the wheel disc 610 has a wave structure on the inside, i.e. that side on which the wheel rim 602 is connected to the rear side of the outer ring section 618 via a welded connection, wherein the wave crests R4c, R6c, R8c, R10c, R12c, R14c and R16c are respectively in the area of disc transition surface 620; wave troughs R5c, R7c, R9c, R11c, R13c, R15c, R17c are respectively formed between these wave crests.

The outer ring section 618, which at the same time forms the ring zone with the aerodynamic surface running perpendicular to the wheel axle, also has a minimum wave crest R18c on the inside, and the inner ring section 615 is also provided with a wave trough R1c and a wave crest R2c, whereas the transition section 615 has only a minimally designed wave trough R3c between the adjacent wave crests R2c, R4c. The material thickness in the area of the wave troughs and wave crests R2c to R4c is thicker than the actual starting thickness of the preform, as indicated by the solid line 650. The wheel disc 610 therefore has fourteen changes between wave crest and wave trough in the transition area alone. As the rim flange 621 is formed directly on the outer ring section 618, the vehicle wheel 601 is also a so-called “full-face vehicle wheel”.

FIG. 12 shows a further exemplary embodiment of a vehicle wheel 701 with a wheel disc 710 according to the invention, which is connected to a rim 702 via a welded connection. Here, however, it is a rim 702 that is designed in the usual way with both rim flanges, thus also the outer rim flange 705. The connection between the outer ring section 718 of the wheel disc 710 takes place via an inwardly bent ring collar 760, which is at least partially welded to the rear side of the rim 702 and at the same time forms the radial outer end of the wheel disc. The transition surface 720 of the wheel disc 710 again has a wave structure on the rear side, which forms the inner side in the assembled state, with wave crests R3d, R5d, R7d only schematically indicated here and wave troughs R2d, R6d lying in between. The front side of the wheel disc 720, on the other hand, has a smooth, high-quality surface and is preferably used as the visible surface of the vehicle wheel without post-processing. However, it can also be painted or reworked in some other way.

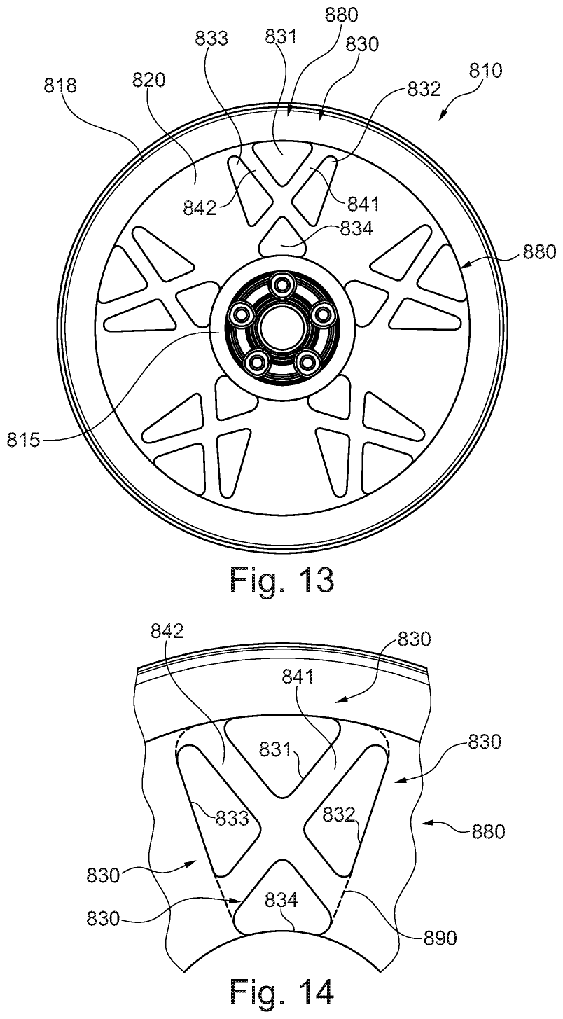

FIG. 13 shows yet another exemplary embodiment of a vehicle wheel with a wheel disc 820 according to the invention. Here, too, only the rear side of the wheel disc 810 is provided on one side with a wave structure with multiple alternating wave crests and wave troughs, as described above (not shown). The transition surface 820 between the radial outer ring section 818, which forms a ring zone running several centimetres perpendicular to the wheel axle (not shown) to improve aerodynamics, and the inner ring section 815 has five times the same pattern field 880, with respectively four ventilation holes 830 with hole contours 831, 832, 833, 834 different from each other. The hole contours 831, 834 have an essentially triangular basic shape, wherein the base is respectively located radially on the outside of the hole contour 831 or radially on the inside of the hole contour 834. The hole contours 832 and 833 are identical to one another, but are arranged in a mirror-inverted manner. The individual ventilation holes 830 with the hole contours 831 to 834 are punched out or cut out in a subsequent method step after the wave structure has been produced. The positioning takes place in such a way that bridge webs 841, 842 remain between adjacent ventilation holes with the corresponding hole contours 831 to 834, which in turn cross each other. A single pattern field 880 is shown enlarged in FIG. 14. The entire pattern field 880 with the four ventilation holes 830 with the hole contours 831 to 834 extends over the area of a very large trapezoidal ventilation hole, as indicated by the dashed line 890. Due to the concentric wave troughs and wave crests, the bridge webs 841, 842 crossing each other have changes in material thickness on the inside, as do the wide areas of the wheel disc transition surface 820 remaining between two pattern fields 880. The wave structure enables in particular a wide variety of design variants with respect to the hole contours and the bridge webs remaining between the hole contours, as the changes in material thickness ensure an additional reinforcement with regard to the loads occurring during driving at the same time. The vehicle wheel designer can choose from a plurality of different hole contours and can then, via a suitable wave structure, influence the rigidity behaviour of the wheel disc which is attached during flow forming, particularly in the transition surface 820, to such an extent that even with a plurality of ventilation holes that are attached at irregular intervals to one another, the required profile for rigidity and load capacity is reached.

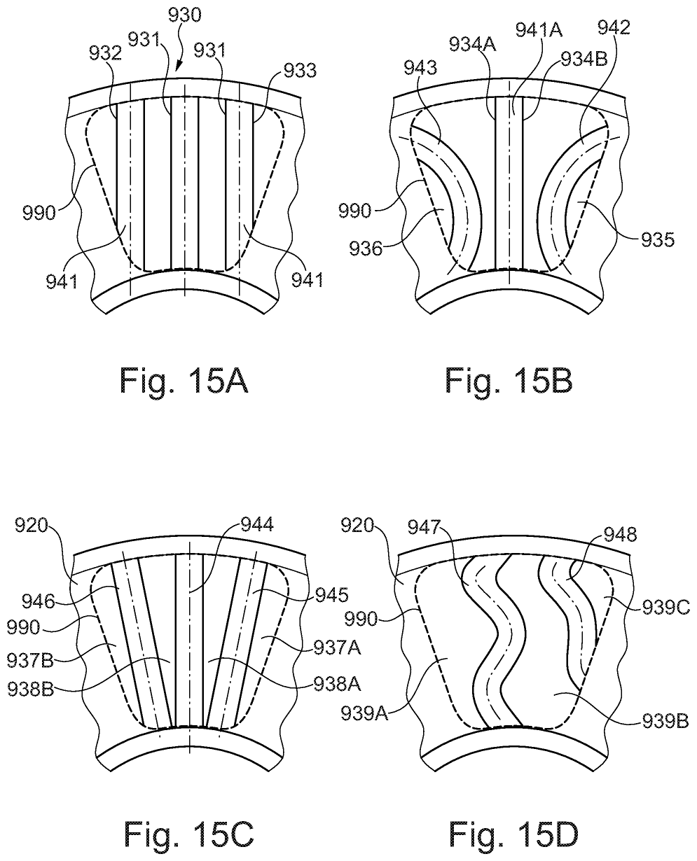

FIGS. 15A to 15D illustrate exemplary different designs of ventilation holes or bridge webs, respectively, in relation to an actually uniform basic ventilation hole contour, as indicated by the dashed line 990 in each case. In FIG. 15A, the respective bridge webs 941A are parallel to each other; the two central ventilation holes 930 have strip-shaped hole contours 931, the two side ventilation holes have irregular hole contours 932, 933, which are designed mirror-inverted to each other. FIG. 15B shows a central, straight bridge web 941A and two curved bridge webs 942, 943 for a wheel disc with a base window 990 of the same size. The bridge webs are formed by correspondingly cutting the hole contours 934A, 934B, 935, 936 for ventilation holes.

FIG. 15C again shows bridge webs 944, 945, 946 for a ventilation hole with the dashed basic shape 990, which respectively run in a straight line, wherein the centre bridge web 944 lies on a radial line, while the two bridge webs 945, 946 run at an angle thereto or are skewed; the bridge webs can lie on radial lines or deviate therefrom. Hole contours 937A, 937B, 938A, 938B are generated between the respective bridge webs 944, 945, 946 and the non-cut-out area of the wheel disc transition surface 920, which hole contours ensure a new, arbitrary styling of such a vehicle wheel. It goes without saying that the respective hole contours 937A, 937B, 938A, 938B are cut out during manufacture so that corresponding bridge webs 944, 945, 946 remain.

FIG. 15D shows yet another exemplary embodiment, in which hole contours 939A, 939B and 939C are cut out in the basic form 990 for a ventilation hole, which contours ensure that irregular bridge webs 947, 948 remain. Here, too, the wave structure of concentric wave crests and wave troughs on the rear side of the wheel disc surfaces 920 or the bridge webs 947, 948 provides for a corresponding reinforcement, which enables the diversity of variants with regard to the hole contours,

Numerous modifications will become apparent to the person skilled in the art from the foregoing description, which modifications shall fall within the scope of the appended claims. The number of wave crests and wave troughs per wave structure is only an example in the individual exemplary embodiments. The same applies to the respective hole contours, which are only intended to basically specify and describe how and with what variety ventilation holes can be fastened and provided on a wheel disc with a wave structure according to the invention, which ensure multiple changes in material thickness between the inner and outer ring section.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

1. A wheel disc for vehicle wheels with a wheel disc body manufactured from a metallic preform by flow forming with a tool against a spinning chuck, which wheel disc body has a radial inner connecting flange provided with several bolt holes and a central hub hole, a stretched disc transition surface subsequently provided with ventilation holes and a radial outer disc edge, wherein the transition surface has a material thickness that, at least partially, changes several times when viewed in the radial direction, and all ventilation holes are attached by punching or cutting between a first inner ring section generated during flow forming, which is arranged between the connecting flange and the transition surface, and a second outer ring section generated during flow forming, which is arranged between the transition surface and the disc edge, wherein the transition surface between the inner ring section and the outer ring section has several changes in material thickness generated during flow forming by displacement of the tool and, viewed in the radial direction, effects a wave structure on the surface facing the tool during flow forming.

2. The wheel disc according to claim 1, wherein the outer disc edge has an end section which is designed as a rim flange such that a rear side of the preform which faces the spinning chuck during flow forming is usable as the visible side of the wheel disc, or the outer disc edge has an end section which is connectable to a wheel rim such that a rear side of the preform which faces the spinning chuck during flow forming is usable as the visible side of the wheel disc.

3. The wheel disc according to claim 1, wherein the transition surface has, at least on the upper side of the preform facing the tool during flow forming, a wave structure with more than 3 wave crests (R4, R6, R8) and wave troughs (R5, R7, R9).

4. The wheel disc according to claim 3, wherein the wave crests (R4, R6, R8) and the wave troughs (R5, R7, R9) have radii of curvature, wherein mutually adjacent wave crests (R4) and wave troughs (R5) preferably have different radii of curvature and/or the wave troughs (R5, R7, R9) have larger radii of curvature than the wave crests (R4, R6, R8).

5. The wheel disc according to claim 1, wherein the transition surface also has, at least partially, on the rear side facing the spinning chuck during flow forming, a wave structure generating changes in material thickness with wave troughs (R8b, R12b) and wave crests (R6b, R10b).

6. The wheel disc according to claim 1, wherein the ventilation holes in the transition surface have at least two hole contours that differ from one another or hole contours arranged differently from one another, wherein these hole contours together form a pattern field which is repeated in the circumferential direction at least one more time.

7. The wheel disc according to claim 6, wherein each pattern field has several ventilation holes with different hole contours and intermediate struts between the ventilation holes with changing material thickness.

8. The wheel disc according to claim 6, wherein each pattern field has at least one partial section partially designing the transition surface, which section adjoins the inner ring section, is not interrupted by ventilation holes, and has a changing material thickness viewed in the radial direction.

9. The wheel disc according to claim 1, wherein the ventilation holes in the transition surface have at least two hole contours which differ from one another or hole contours which are arranged differently from one another, wherein bridge webs with a material thickness that changes in the radial direction are arranged between adjacent hole contours.

10. The wheel disc according to claim 9, wherein the bridge webs have a constant width at least partially over a partial extension length.

11. The wheel disc according to claim 9 wherein several bridge webs run parallel to one another or skew to one another and/or cross each other, and/or wherein the bridge webs are designed as round curves, straight struts and/or asymmetrical struts.

12. The wheel disc according to claim 9, wherein several ventilation holes formed by different hole contours form a window-like hole group together with the associated bridge webs, which group covers a window area with a circumferential contour which corresponds to a round hole, a triangular hole with rounded corners or a square hole with rounded corners.

13. The wheel disc according to claim 1, wherein the inner ring section has a material thickness that changes in the radial direction and has a wave structure with only one wave trough on the surface facing the tool during flow forming, wherein the inner ring section preferably merges into the transition surface (20) via a transition curve having a wave trough.

14. The wheel disc according to claim 13, wherein the inner ring section between the connecting flange and the transition surface has a wave structure with one wave trough or two wave troughs.

15. The wheel disc according to claim 1, wherein the wheel disc is designed as a full-face wheel disc with a rim flange and the outer ring section has a ring zone with a planar surface on the visible side, aligned orthogonally to an axis of rotation of the wheel disc, wherein the ring zone has a length of at least 25 mm, 28 mm, 32 mm or 35 mm in the radial direction, and/or preferably a length in the radial direction, which is larger than 1/20 of the wheel disc diameter.

16. The wheel disc according to claim 15, wherein that the ring zone has at least one wave crest or has both a wave crest and a wave trough.

17. A method for manufacturing wheel discs for vehicle wheels, with the steps of flow forming a metallic preform on a flow forming machine against a spinning chuck using at least one spinning roller as a tool, generating a connecting flange, a disc transition surface and a disc edge on a wheel disc body in the flow forming step, wherein the transition surface in the flow forming step is at least partially given a material thickness that changes several times when viewed in the radial direction,
generating a first inner ring section between the connecting flange and the transition surface and a second outer ring section between the transition surface and the disc edge,
punching or cutting ventilation holes in the transition surface in a subsequent processing step, wherein
the transition surface between the inner ring section and the outer ring section receives several changes in material thickness generated during flow forming by displacement of the tool and, viewed in the radial direction, effecting a wave structure on the surface facing the tool during flow forming,
all ventilation holes are made by punching or cutting at least two mutually different hole contours or mutually differently arranged hole contours between the inner ring section and the outer ring section, and
the arrangement of the ventilation holes and the remaining basic structure on the wheel disc body form a pattern field in the transition surface, which field is repeated at least one more time in the circumferential direction.

18. The method according to claim 17, wherein several ventilation holes with mutually different outer contours are provided in each pattern field, wherein intermediate struts with changing material thickness result between the ventilation holes and at least one partial section is generated which adjoins the inner ring section, is not interrupted by ventilation holes, and partially has a changing material thickness.

19. The method according to claim 17, wherein each pattern field of ventilation holes, bridge webs or intermediate struts and partial sections is determined iteratively in several steps, wherein, in a first step, basic pattern fields with ventilation hole contours are developed from the parameters of rigidity and load-bearing capacity required for a vehicle wheel, which contours are analysed in at least one further step with respect to feasibility, wherein, in a further step, prior to the manufacture of the wheel disc, the arrangement and the contour of the ventilation holes and the change in material thickness between the ring section effecting the wave structure and the position, shape and alignment of the bridge webs or intermediate webs are optimized with respect to vehicle wheel weight and rigidity.

20. A vehicle wheel, wherein the wheel disc is designed according to claim 1 and/or is manufactured according to the method according to claim 17, a front side visible in the assembly state of the vehicle wheel on a vehicle consists of the side of the wheel disc body pressed against the spinning chuck during flow forming or in the flow forming step.

21. The vehicle wheel according to claim 20, wherein the wheel disc forms a fully formed rim flange and a rim section is connected on the rear side of the wheel disc in the area of the outer disc edge or the outer ring portion radially offset outside to the outer transition curve into the outer ring portion.

22. The vehicle wheel according to claim 21, wherein the wheel disc on the outer ring section has a ring zone with a planar surface aligned orthogonally to an axis of rotation of the vehicle wheel, wherein the ring area has a length of at least 28 mm, 32 mm or 35 mm in the radial direction, and/or preferably has a length in the radial direction that is greater than 1/20 of the wheel disc diameter.

23. The wheel disc according to claim 1, wherein the transition surface has, at least on the upper side of the preform facing the tool during flow forming, a wave structure with more than 3 wave crests and more than 5 wave troughs.

24. The wheel disc according to claim 1, wherein the ventilation holes in the transition surface have at least two hole contours that differ from one another or hole contours arranged differently from one another, wherein these hole contours together form a pattern field which is repeated in the circumferential direction at least three times

25. The method according to claim 17 wherein the field is repeated at least three more times in the circumferential direction.
